(19) United States
(12) Patent Application Publication
(10) Pub. No.: US 2024/0341313 A1
(43) Pub. Date: Oct. 17, 2024

(54) BAKING DEVICE

(71) Applicant: Tsann Kuen (Zhangzhou) Enterprise Co., Ltd., Zhangzhou (CN)

(72) Inventors: Chunyu WU, Zhangzhou (CN); Hanxin QIU, Zhangzhou (CN)

(21) Appl. No.: 18/633,437

(22) Filed: Apr. 11, 2024

(30) Foreign Application Priority Data
Apr. 14, 2023 (CN) 202320839499.X

(51) Int. Cl. A21B 3/13; A47J 37/06

(52) U.S. Cl. CPC A21B 3/135; A21B 3/13; A47J 37/0611

(57) ABSTRACT

A baking device includes a first grill unit and a second grill unit pivotally connected to the first grill unit. The first grill unit includes a first housing, a first grill seat disposed in the first housing and facing the second grill unit, and a first grill. The first grill seat includes a first magnetic component, and the first grill includes a second magnetic component. The first magnetic component is configured to be magnetically adsorbed on the second magnetic component, so that the first grill is configured to be magnetically adsorbed on the first grill seat.

### RELATED APPLICATIONS

This application claims priority to Chinese patent application number 202320839499.X, filed on Apr. 14, 2023. Chinese patent application number 202320839499.X is incorporated herein by reference.

### FIELD OF THE DISCLOSURE

The present disclosure relates to the field of kitchen appliances, and more particularly, to a grill appliance product.

### BACKGROUND OF THE DISCLOSURE

Wafers are popular snack foods in many countries, often found in homes, parties, etc., and sponsors often prepare wafers of different styles in order to provide different eating experiences. Therefore, extensive cleaning is required during activity or other pattern baking pans needs to be replaced. Traditionally, a baking pan is fixedly connected to a baking device by structure clamping, springs, or the like. A specific structure for the baking pan and the baking device needs to be designed, and the diversification of the baking pan patterns undoubtedly increases the difficulty and the cost of product mold manufacturing for wafer maker manufacturers.

Accordingly, there is a need for improvements over the prior art.

### BRIEF SUMMARY OF THE DISCLOSURE

The present disclosure provides a baking device to solve the deficiencies in the background, which can be conveniently cleaned or replaced by frying and roasting pans with different frying and roasting patterns and solve the problems of difficulty of mold manufacturing and increased manufacturing cost of products.

In order to solve the technical problem, a technical solution of the present disclosure is as follows.

A baking device comprises a first grill unit and a second grill unit pivotally connected to the first grill unit. The first grill unit comprises a first housing, a first grill seat disposed in the first housing and facing the second grill unit, and a first grill. The first grill seat comprises a first magnetic component, and the first grill comprises a second magnetic component. The first magnetic component is configured to be magnetically adsorbed on the second magnetic component, so that the first grill is configured to be magnetically adsorbed on the first grill seat. Preferably, the first magnetic component and the second magnetic component are made of a magnetic material that is not demagnetized when heated to more than 320° C.

The consumer can simply separate or attach the first grill to the first grill unit through the attraction of the magnetic coupling of the first magnetic component and the second magnetic component based upon the need to clean or replace other pattern frying and roasting pans.

Furthermore, one of the first grill seat or the first grill comprises a position groove, and the other one of the first grill seat or the first grill comprises a position protrusion. The first magnetic component and the second magnetic component are respectively disposed at a bottom of the position groove and a top of the position protrusion, and the first grill is configured to be vertically attached to and magnetically adsorbed on the first grill seat through the position groove and the position protrusion. Preferably, the position groove is a cross-shaped groove, and a first fastening component enables one of the first magnetic component or the second magnetic component to be fixedly connected to a bottom of the cross-shaped groove. A second fastening component is fixedly connected to the other one of the first magnetic component or the second magnetic component to form the position protrusion, and the first fastening component and the second fastening component are perpendicular to each other.

Furthermore, one of the first grill seat or the first grill comprises a first aligning member and the other one of the first grill seat or the first grill comprises a second aligning member, so that the first grill is configured to be horizontally attached to the first grill seat.

Because the first grill and the first grill seat are respectively disposed with the first magnetic component and the second magnetic component, when the first grill and the first grill seat are attracted together at a wrong position, adjustment is required to be laboriously carried out due to the first magnetic component and the second magnetic component. The dislocation between the first grill and the first grill seat can be reduced by a vertical matching of the position groove and the position protrusion and a horizontal matching of the first aligning member and the second aligning member.

Compared with the existing techniques, the technical solution has the following advantages.

The baking device can be simply replaced or cleaned by matching with different pans of different frying and roasting patterns, and the baking device has the advantages of simple structure, low mold manufacturing difficulty, a great reduction of the rejection rate of production, and indirect low manufacturing cost.

### BRIEF DESCRIPTION OF THE DRAWINGS

FIG. 1 illustrates a perspective view of a baking device of a first embodiment of the present disclosure.

FIG. 2 illustrates an exploded view of the baking device of the first embodiment of the present disclosure.

FIG. 3 illustrates a perspective view of a baking device of a second embodiment of the present disclosure.

FIG. 4 illustrates an exploded view of the baking device of the second embodiment of the present disclosure.

FIG. 5 illustrates a front view of a frying and roasting seat of the baking device of the second embodiment of the present disclosure.

FIG. 6 illustrates a rear view of a frying and roasting pan of the baking device of the second embodiment of the present disclosure.

1—baking device; 11—first grill unit; 111—first housing; 112—first grill seat; 1121—first magnetic component; 1122—position grooves; 1123—first fastening component; 113—first grill; 1131—second magnetic component; 1132—position protrusion; 1133—second fastening component; 12—second grill unit 12.

### DETAILED DESCRIPTION OF THE EMBODIMENTS

The present disclosure will be further described below in combination with the accompanying drawings and embodiments.

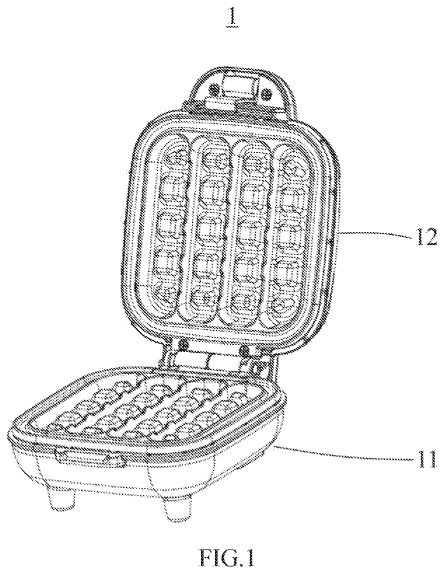

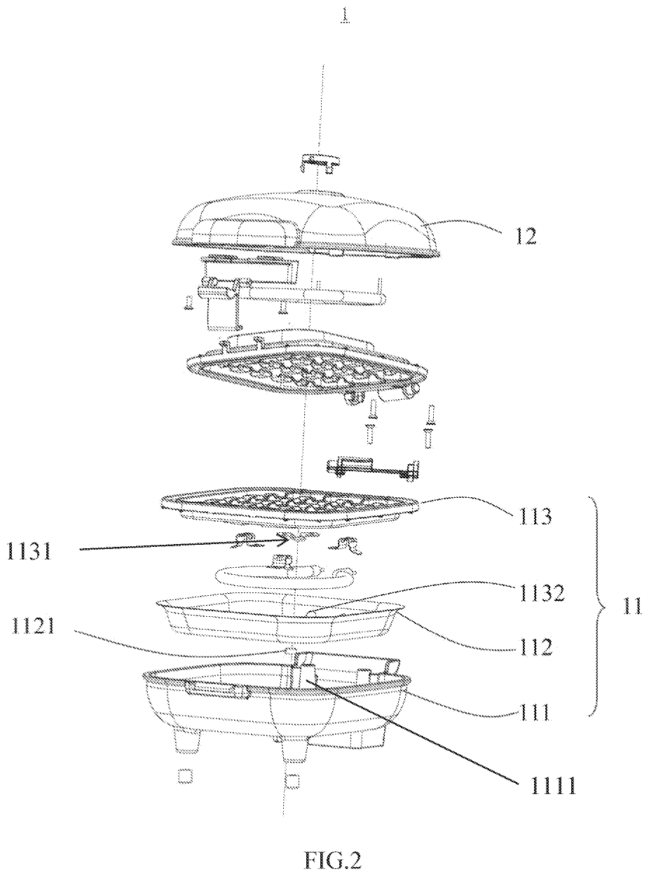

Referring to FIG. 1 and FIG. 2, a first embodiment is provided. A baking device 1 in the present disclosure comprises a first grill unit 11 and a second grill unit 12 pivotally connected to the first grill unit 11. In the embodiment, the first grill unit 11 is a lower grill seat, and the second grill unit 12 is an upper grill seat. The upper grill seat is configured to be rotatably opened and closed relative to the lower grill seat along an angular direction. The lower grill seat and the upper grill seat can be interchanged, and the present disclosure is not limited to this regard.

The first grill unit 11 comprises a first housing 111, a first grill seat 112 disposed in the first housing 111 and facing the second grill unit 12, and a first grill 113. The first grill seat 112 comprises a first magnetic component 1121, and the first grill 113 comprises a second magnetic component 1131. The first magnetic component 1121 is configured to be magnetically adsorbed on the second magnetic component 1131, so that the first grill 113 can be magnetically adsorbed on the first grill seat 112. In the embodiment, the first magnetic component 1121 and the second magnetic component 1131 may be two magnets attracted to each other, or one of the first magnetic component 1121 or the second magnetic component 1131 is a magnet, and the other one of the first magnetic component 1121 or the second magnetic component 1131 is a magnetic conductive member, such as: iron (Fe), silicon (Si), boron (B), etc. Preferably, the first magnetic component 1121 and the second magnetic component 1131 are made of a magnetic material that is not demagnetized when heated to more than 320° C.

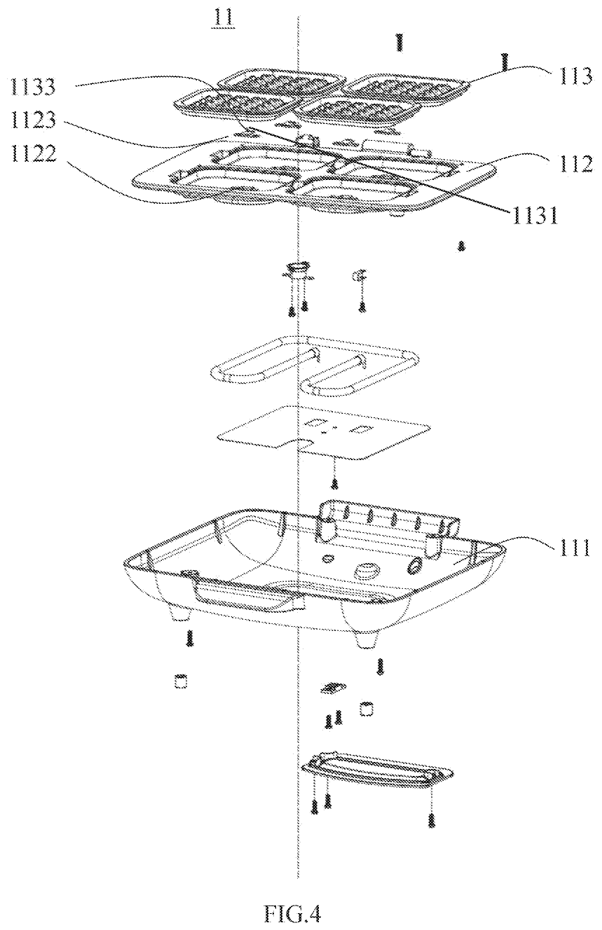

Referring to FIG. 2 in combination with FIG. 4 in a second embodiment, one of the first grill seat 112 or the first grill 113 comprises a position groove 1122, and the other one of the first grill seat 112 or the first grill 113 comprises a position protrusion 1132. The first magnetic component 1121 and the second magnetic component 1131 are respectively disposed at a bottom of the position groove 1122 and a top of the position protrusion 1132. Therefore, the first grill 113 can be vertically attached to and magnetically adsorbed on the first grill seat 112 through the position protrusion 1132 being inserted into the position groove 1122. In the embodiment, the first housing 111 has a first post structure 1111, and the first grill seat 112 has a second post structure (i.e., the position protrusion 1132) which is the same as the first post structure. The first post structure and the second post structure are hollow structures, and the second post structure can be sleeved on the first post structure. One magnet (i.e., one of the first magnetic component 1121 or the second magnetic component 1131) is clamped at a top of the first post structure of the first housing 111 and at a bottom of the second post structure of the first grill seat 112. A back of the first grill 113 has a groove structure (i.e., the position groove 1122) aligned with an axis of the first post structure 1111 and the second post structure, and another magnet (i.e., the other one of the first magnetic component 1121 or the second magnetic component 1131) is locked in the groove structure, so that a user can directly align the second post structure with the groove structure. The first grill 113 is attached to the first grill seat 112 by a magnetic force.

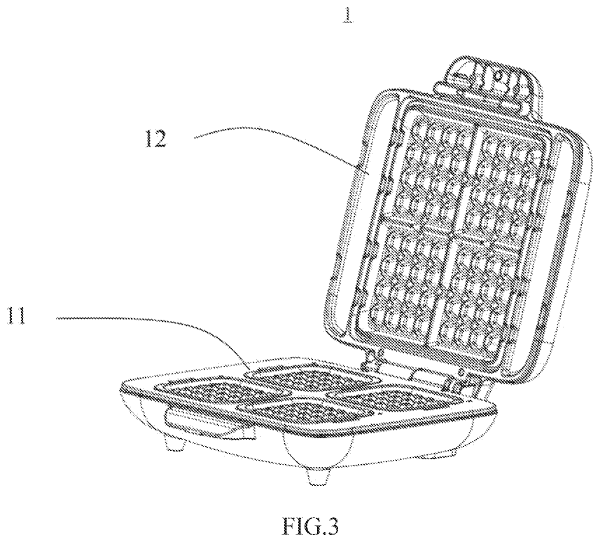

Referring to FIGS. 3 to 6, the second embodiment is provided. The difference between the first embodiment and the second embodiment is that the position groove 1122 is a cross-shaped groove. A first fastening component 1123 enables one of the first magnetic component 1121 or the second magnetic component 1131 to be fixedly connected to a bottom of the cross-shaped groove, and a second fastening component 1133 is fixedly connected to the other one of the first magnetic component 1121 or the second magnetic component 1131 to form a structure as the same as the position protrusion 1132 in the first embodiment. The first fastening component 1123 and the second fastening component 1133 are perpendicular to each other.

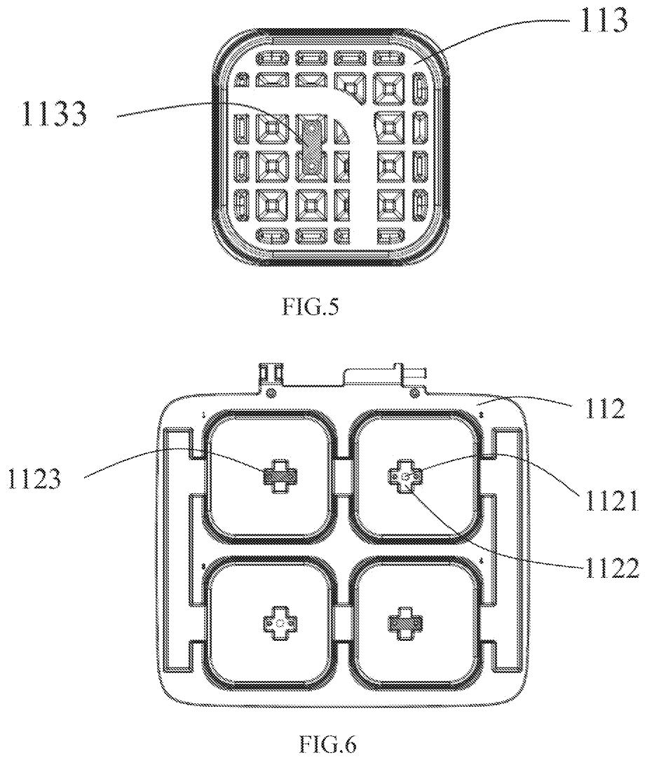

Referring to FIGS. 5 and 6, the first grill seat 112 comprises the cross-shaped groove, and one magnet (i.e., one of the first magnetic component 1121 or the second magnetic component 1131) is fixedly connected to a bottom of the cross-shaped groove by the first fastening component 1123. The back of the first grill 113 is locked with another magnet (i.e., the other one of the first magnetic component 1121 or the second magnetic component 1131) by the second fastening component 1133 to form a protrusion structure (i.e., the position protrusion 1132). In particular, a length direction of the first fastening component 1123 is perpendicular to a length direction of the second fastening component 1133, so that the protrusion structure can inserted into one groove of the cross-shaped groove, and the first grill 113 is attached to the first grill seat 112 by the magnetic force.

That is, one of the first grill seat 112 or the first grill 113 comprises a first aligning member (i.e., the position groove 1122), and the other one of the first grill seat 112 or the first grill 113 comprises a second aligning member (i.e., the second fastening component 1133), so that the first grill 113 can be horizontally attached to the first grill seat 112.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A baking device, comprising:
a first grill unit, and
a second grill unit pivotally connected to the first grill unit, wherein:
the first grill unit comprises a first housing, a first grill seat disposed in the first housing and facing the second grill unit, and a first grill,
the first grill seat comprises a first magnetic component,
the first grill comprises a second magnetic component, and
the first magnetic component is configured to be magnetically adsorbed to the second magnetic component, so that the first grill is configured to be magnetically adsorbed on the first grill seat.

2. The baking device according to claim 1, wherein:
the first magnetic component and the second magnetic component are made of a magnetic material that is not demagnetized when heated to more than 320° C.

3. The baking device according to claim 1, wherein:
one of the first grill seat or the first grill comprises a position groove,
the other one of the first grill seat or the first grill comprises a position protrusion,
the first magnetic component and the second magnetic component are respectively disposed at a bottom of the position groove and a top of the position protrusion, and
the first grill is configured to be vertically attached to and magnetically adsorbed on the first grill seat through the position groove and the position protrusion.

4. The baking device according to claim 3, wherein:
the position groove is a cross-shaped groove,
a first fastening component enables one of the first magnetic component or the second magnetic component to be fixedly connected to a bottom of the cross-shaped groove,
a second fastening component is fixedly connected to the other one of the first magnetic component or the second magnetic component to form the position protrusion, and
the first fastening component and the second fastening component are perpendicular to each other.

5. The baking device according to claim 1, wherein:
one of the first grill seat or the first grill comprises a first aligning member and the other one of the first grill seat or the first grill comprises a second aligning member, so that the first grill is configured to be horizontally attached to the first grill seat.
